(19) United States
(12) Patent Application Publication
(10) Pub. No.: US 2026/0305590 A1
(43) Pub. Date: Oct. 8, 2026

(54) SEGMENTED FISHING LURE

(71) Applicant: Robert Ossola, Trinidad, CO (US)

(72) Inventor: Robert Ossola, Trinidad, CO (US)

(21) Appl. No.: 19/629,318

(22) Filed: Mar. 26, 2026

Related U.S. Application Data
(60) Provisional application No. 63/782,653, filed on Apr. 3, 2025.

(51) Int. Cl. A01K 85/00

(52) U.S. Cl. CPC A01K 85/1881

(57) ABSTRACT

An improved fishing lure which includes a segmented metallic body designed to enhance fish attraction is described. The lure body is divided into at least two sections by an oblique diagonal split line or offset positioned approximately two-thirds from the head end, enabling for rotational and oscillatory movement of the tail section relative to the head section via a coupling mechanism such as a split ring(s) or swivel connector. One or more treble hooks are mounted at the tail end and optionally along the sides, generating underwater noise upon contact with the body. In one embodiment, the lure includes three segments with dual diagonal splits for complex, lifelike motion. The lure surface incorporates reflective materials and geometric or holographic markings to increase visibility in both cold and warm water environments. The lure is operable at varying retrieval speeds and motion patterns to simulate distressed or injured prey.

### CROSS-REFERENCE TO RELATED APPLICATION

The present application claims priority to, and the benefit of, U.S. Provisional Application No. 63/782,653 which was filed on Apr. 3, 2025 and is incorporated herein by reference in its entirety.

### FIELD OF THE INVENTION

The present invention generally relates to fishing equipment. More specifically, the present invention relates to an improved fishing lure configured to generate lifelike motion and sound for enhanced fish attraction. The invention comprises a segmented metallic body having a diagonally split structure with at least two interconnected sections joined by a swivel connector, a split ring, or a combination of split rings, enabling multi-axis articulation during retrieval. The tail section rotates and sways relative to the head section, creating erratic movement patterns that mimic the behavior of injured or distressed prey. The lure further includes treble hook mounting points and a reflective surface featuring geometric markings or holographic patterns for increased visual stimulation underwater. In certain embodiments, secondary hook positions and spaced connectors are included to produce clicking sounds upon collision. Accordingly, the present disclosure makes specific reference thereto. Nonetheless, it is to be appreciated that aspects of the present invention are also equally applicable to other like applications, devices, and methods of manufacture.

### BACKGROUND

By way of background, fishing lures have been used to simulate the appearance and behavior of prey in order to attract predatory fish. The most commonly used fishing lures are spoon lures, castaway lures, and crocodile lures. The traditional lures are commonly formed from a single, curved metal body that reflects light and moves with a fluttering or wobbling action when retrieved through water. While conventional lures can be effective under certain conditions, many anglers continue to experience low catch rates or inconsistent fish strikes throughout the day.

One challenge with conventional lures is that they often lack sufficient variability in motion or sensory stimulation to consistently engage fish across varying water conditions and species behaviors. In natural environments, fish are drawn not only to visual cues but also to erratic movements and subtle sounds that mimic the behavior of injured or distressed prey. Accordingly, anglers desire an improved fishing lure capable of increasing strike probability and effectiveness across a broader range of fishing scenarios.

Therefore, there exists a long-felt need in the art for an improved fishing lure that enhances the angler's ability to attract and catch fish by more accurately replicating the motion, sound, and appearance of natural bait. There is a long-felt need for a lure that performs effectively across a wide range of water conditions, temperatures, and fish species. Additionally, there is a long-felt need for a fishing lure that includes a split portion along the length of the lure that modifies its movements to exhibit increased action in water. Furthermore, there is a long-felt need for a lure with multiple points of articulation that can mimic the behavior of distressed or injured prey fish. Finally, there is a long-felt need for a robust, easy-to-use lure structure that accommodates flexible hook configurations and supports enhanced visual and motion-based fish attractions.

The subject matter disclosed and claimed herein, in one embodiment, comprises an improved fishing lure having a metallic body configured in a spoon-or castaway-style profile. The body includes a diagonal split positioned approximately two-thirds of the distance from the head end toward the tail end, forming an oblique division between a first body section and a second body section. The split is angled relative to the longitudinal axis of the lure, and the sections are joined via a coupling mechanism such as split ring(s) or swivel connector. The coupling permits oscillatory and rotational movement of the tail section relative to the head section during retrieval. As the lure is pulled through water, the rear section sways and rotates independently, producing unpredictable and erratic motion patterns that simulate natural prey behavior and increase the likelihood of a strike.

In another embodiment, the fishing lure further comprises a reflective outer surface decorated with colored geometric markings, holographic patterns, or scale-like textures to enhance visibility in water. One or more treble hooks may be mounted at the tail or along the sides of the second body section. Additional segments and dual diagonal splits may be incorporated, creating a three-part structure that increases movement complexity and lifelike simulation.

In this manner, the improved fishing lure of the present invention fulfills the long-felt need for a mechanically dynamic, visually stimulating, and acoustically active fish-attracting device. The lure provides anglers with a highly effective tool capable of mimicking erratic baitfish behavior, increasing engagement from a wide range of predatory species. The lure incorporates multi-axis articulation, flexible hook placement, and customizable finishes, to offer superior performance compared to traditional rigid-body lures. The design may be manufactured from corrosion-resistant materials, supports both cold and warm water use, and is suitable for freshwater and saltwater environments.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing lure. The fishing lure comprises a body extending along a longitudinal axis between a head end and a tail end, the body includes a diagonal split line located at a predetermined distance such as two-thirds of the distance from the head end toward the tail end. The diagonal split line is oblique to the longitudinal axis and forms an angle between 30 and 60 degrees relative to the longitudinal axis, wherein the diagonal split line divides the body into a first body section and a second body section. The first body section includes at least one aperture along an edge of the split line, and the second body section includes a corresponding aperture along an adjacent edge of the split line. A coupling member extends through the apertures to removably connect the first and second body sections, the coupling member is configured to permit rotational and oscillatory movement of the second body section relative to the first body section during retrieval through water.

In another aspect, a treble hook connected to the tail end of the second body section by a swivel connector or split ring connector, and wherein the body has a visually reflective outer surface and includes at least one colored geometric marking or holographic scale pattern configured to enhance visibility to fish.

In another embodiment, a segmented fishing lure is disclosed. The fishing lure comprises a rigid body extending from a head end to a tail end and divided into a first body section and a second body section by an oblique diagonal split line positioned approximately two-thirds of the distance from the head end. Each of the first and second body sections includes a circular aperture spaced inward from a corresponding split edge, a coupling mechanism passes through the apertures, permitting oscillatory movement of the body sections relative to each other, a primary treble hook is mounted at the tail end of the second body section, a secondary hook attachment point is disposed on a side of the second body section for optionally connecting an additional treble hook, wherein the additional treble hook is positioned to contact the body during motion and generate underwater noise, and wherein the lure includes a line attachment ring at the head end for securing a fishing line.

In one embodiment, the fishing lure contains two oblique diagonal split lines to divide the body into three sections: a head section, a middle section, and a tail section. The head section includes an eye feature and a connection point for a front treble hook, a first coupling member connects the head section and the middle section via a first split line, and a second coupling member connects the middle section and the tail section via a second split line, each coupling member comprises a split ring, pair of split rings, or swivel to permit multi-directional articulation between segments, wherein the dual-segment articulation creates compound erratic movement of the lure in water during retrieval to simulate injured prey behavior, wherein the tail section includes a mounting point for a rear treble hook.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the improved fishing lure of the present invention in accordance with the disclosed structure;

FIG. 2 illustrates a perspective view of another embodiment of the improved fishing lure of the present invention in accordance with the disclosed structure;

FIG. 3 illustrates a perspective view showing the improved fishing lure with three distinct and interconnected segments in accordance with one embodiment of the present invention;

FIG. 4 illustrates a side elevation view of the fishing lure in operation underwater, showing the dynamic and erratic motion enabled by the segmented body construction of the invention;

FIG. 5 illustrates a perspective view of yet another embodiment of the improved fishing lure of the present invention in accordance with the disclosed structure;

FIG. 6 illustrates a perspective view of yet still another embodiment of the improved fishing lure of the present invention in accordance with the disclosed structure; and

FIG. 7 illustrates a perspective view of a further embodiment of the improved fishing lure of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved fishing lure that enhances the angler's ability to attract and catch fish by more accurately replicating the motion, sound, and appearance of natural bait. There is a long-felt need for a lure that performs effectively across a wide range of water conditions, temperatures, and fish species. Additionally, there is a long-felt need for a fishing lure that includes a split portion along the length of the lure that modifies its movements to exhibit increased action in water. Furthermore, there is a long-felt need for a lure with multiple points of articulation that can mimic the behavior of distressed or injured prey fish. Finally, there is a long-felt need for a robust, easy-to-use lure structure that accommodates flexible hook configurations and supports enhanced visual and motion-based fish attractions.

The present invention, in one exemplary embodiment, is a fishing lure. The fishing lure comprises a rigid body extending from a head end to a tail end and divided into a first and second body section by an oblique diagonal split line positioned approximately two-thirds of the distance from the head end. Each of the first and second body sections includes a circular aperture spaced inward from a corresponding split edge, a coupling mechanism passes through the apertures, permitting oscillatory movement of the body sections relative to each other, a primary treble hook is mounted at the tail end of the second body section, a secondary hook attachment point is disposed on a side of the second body section for optionally connecting an additional treble hook, wherein the additional treble hook is positioned to contact the body during motion and generate underwater noise, and wherein the lure includes a line attachment ring at the head end for securing a fishing line.

Reference will now be made in detail to the present preferred embodiments of the invention, examples of which are illustrated in the accompanying drawings. Wherever possible, the same reference numerals are used in the drawings and the description to refer to the same or like parts.

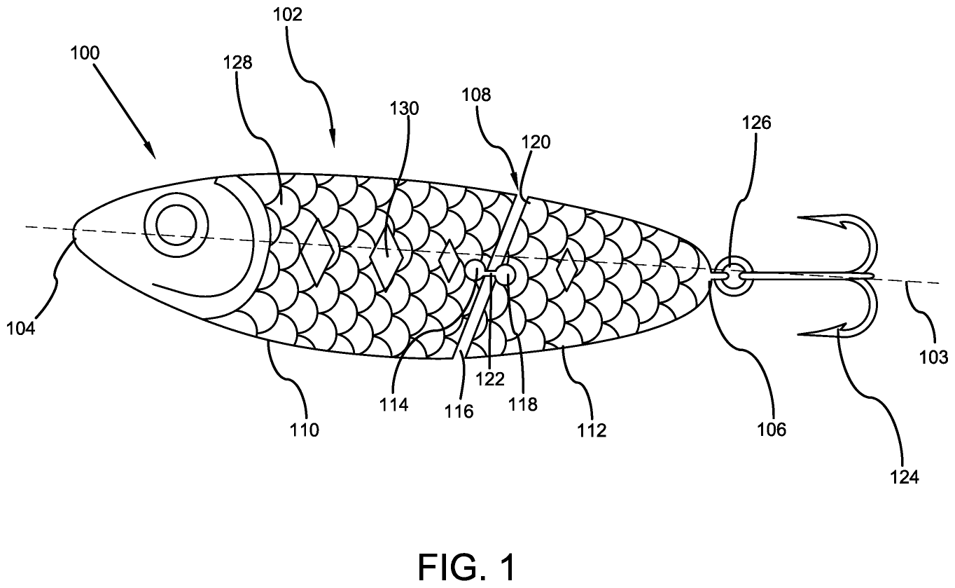

Referring initially to the drawings, FIG. 1 illustrates a perspective view of one potential embodiment of the improved fishing lure of the present invention in accordance with the disclosed structure. The improved fishing lure 100 of the present invention is designed to improve fish-catching effectiveness by mechanical and visual enhancements over traditional spoon and castaway lures. More specifically, the fishing lure 100 includes a body 102 formed from a substantially rigid metallic material shaped in a specific configuration such as spoon, castaway, or crocodile-like configuration. The body 102 extends longitudinally along a longitudinal axis 103 between a head end 104 and a tail end 106, wherein the body 102 includes a diagonal split line 108 which divides the body 102 into a first body section 110 and a second body section 112. The diagonal split line 108 is positioned approximately two-thirds of the distance from the head end 104 toward the tail end 106 along the longitudinal axis 103. In one exemplary embodiment, the first body section 110 having a first length comprising from 60 to 70 percent of the overall length of the body 102. It is to be appreciated that the second body section 112 having a second length from 40 to 30 percent of the overall length of the body 102. Further, the diagonal split line 108 is oblique to the longitudinal axis 103 and forms an angle between 30 and 60 degrees relative to the longitudinal axis 103 of the body 102. In another embodiment, the diagonal split line 108 is oblique to the longitudinal axis 103 and forms an angle between 35 and 55 degrees relative to the longitudinal axis 103 of the body 102. In yet still another embodiment, the diagonal split line 108 is oblique to the longitudinal axis 103 and forms an angle between 40 and 50 degrees relative to the longitudinal axis 103 of the body 102.

The first body section 110 has at least one aperture 114 along an edge 116 of the split line 108 and the second body section 112 has a similar aperture 118 along the adjacent edge 120 of the split line 108. Each aperture 114, 118 is circular and has a diameter in the range from about 1/20 inches to about 1/14 inches and preferably about 1/16 inches. In the preferred embodiment, the apertures 114, 118 are disposed inward from the respective edges 116, 120 and have respective aperture centers from 1/16 inch to 3/16 inch from the corresponding edge.

A coupling member 122 passes through the apertures 114, 118 to removably attaching (i.e., selectively attaching) the first body section 110 and the second body section 112. The coupling member 122 is preferably in the form of a metallic split ring(s) or swivel connector and is configured to enable rotational and oscillatory movement of the second body section 112 relative to the first body section 110 about multiple axes during retrieval through water. The improved fishing lure 100 includes a primary treble hook 124 affixed or coupled to the terminal or tail end 106 of the second body section 112 using a second split ring or swivel connector 126 or any other similar connector. The treble hook 124 is configured to maintain a substantially trailing orientation relative to the body 102 during use of the fishing lure 100.

The fishing lure body 102 has a visually reflective outer surface 128, which can be decorated with one or more colored geometric markings or holographic scaling patterns 130 configured to enhance visual stimulus to fish in both cold and warm water environments. It should be noted that the fishing lure 100 is configured for manual or mechanical retrieval at variable speeds with intermittent jerking motions.

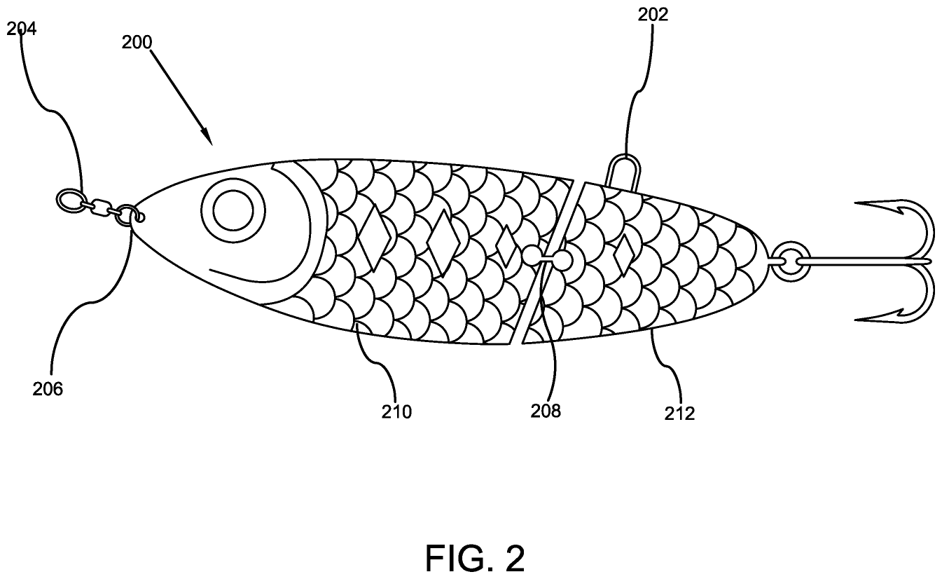

FIG. 2 illustrates a perspective view of another embodiment of the improved fishing lure of the present invention in accordance with the disclosed structure. The fishing lure 200 includes a side hook mount point 202 to attach an additional treble hook for added acoustic activity and motion action. In action, the treble hooks can collide with the body of the fishing lure 200 to produce a clicking noise underwater. For additional movement and creation of erratic motion, additional hooks can be disposed for removably attaching (i.e., selectively attaching) the treble hooks. A line attachment ring 204 is disposed at the head end 206 of the lure 200 and can be used for removably attaching (i.e., selectively attaching) a fishing line or leader. All other specifications of the diagonal split line are similar to the fishing lure 100 of FIG. 1. In some embodiments, a ball-bearing swivel connector 208 can be used for connecting the first and second body sections 210, 212 to enhance multi-directional articulation between the first and second body sections 210, 212.

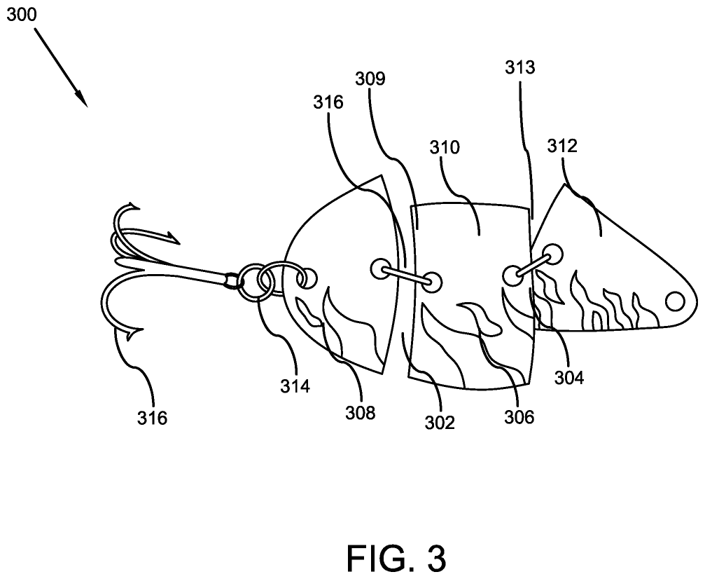

FIG. 3 illustrates a perspective view showing the improved fishing lure with three distinct and interconnected segments in accordance with one embodiment of the present invention. The fishing lure 300 of the present embodiment includes a pair of oblique or diagonal split lines 302, 304 dividing the main body 306 into a head section/segment 308, a middle section 310, and a tail section 312. The head section 308 includes a front treble hook connection 314 for removably connecting a treble hook 316. The head section 308 is connected to first end 309 of the middle section 310 along the first split line 302 using a swivel 316 or any other similar connecting member. The tail section 312 is also connected to the opposite second end 313 of the middle section 310 using a swivel connector. The tail section 312 can accommodate a rear treble hook as per preference of the users. It should be noted that the position of the treble hooks can be customized as per preference of the users and use of the lures. The dual-split design of the present embodiment enhances movement complexity, enabling the lure 300 to produce a more erratic and lifelike action in the water, mimicking an injured or fleeing fish even more effectively than a single-split design.

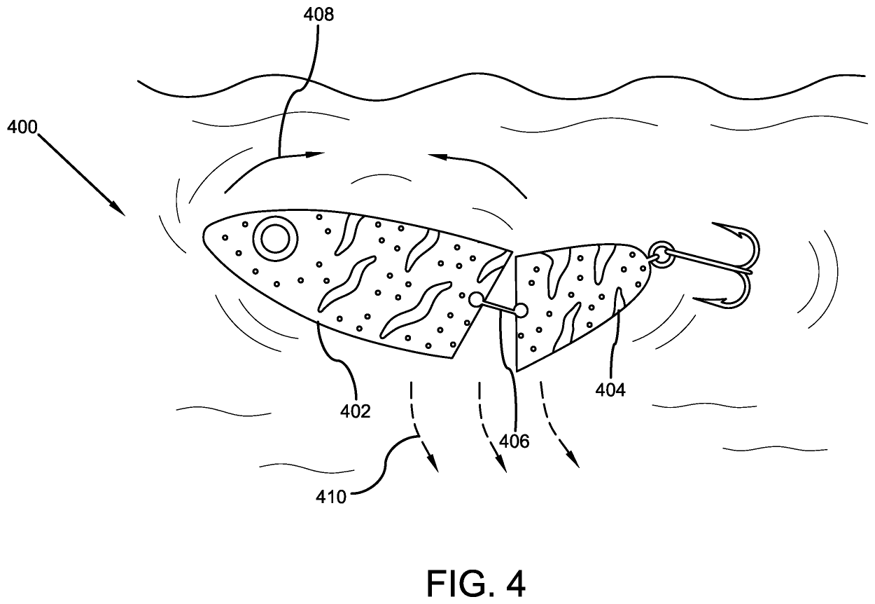

FIG. 4 illustrates a side elevation view of the fishing lure in operation underwater, showing the dynamic and erratic motion enabled by the segmented body construction of the invention. The lure 400 comprises a main forward body section/first body section 402 and a rear tail section 404, coupled via a swivel connector 406 that permits rotational freedom. The lure 400 is depicted traveling through water with directional arrows 408 indicating its erratic, oscillatory path, resulting from water resistance and variable retrieval speeds. The tail section 404 is shown rotated angularly relative to the first body section 402, demonstrating the free articulation achieved through the diagonal split and coupling mechanism described in earlier figures. The dashed arrows 410 beneath the lure indicate sound-generating and directional deflection effects, intended to mimic the unpredictable movement of an injured or distressed baitfish.

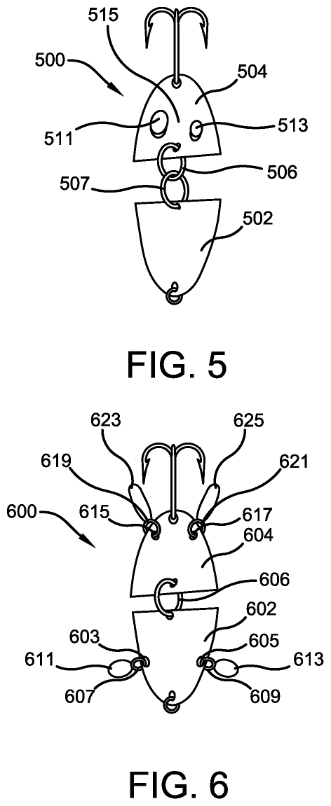

FIG. 5 illustrates another embodiment of a fishing lure including a segmented body construction of the invention. The lure 500 comprises a main forward body section/first body section 502 and a rear tail section 504, coupled via a pair of connectors selected from the group consisting of a pair of swivel connectors (not shown) and a pair of split rings 506, 507 that permits increased rotational freedom. The lure 500 comprises at least one hole passing through the rear tail section 504. As shown, the tail section 504 includes a pair of holes 511, 513 passing therethrough. The holes 511, 513 are formed (i.e., offset rearward) at an angle from 20 degrees to 40 degrees relative to the surface 515 of the rear tail section 504. In one exemplary arrangement, the holes 511, 513 include a diameter from 5/32 inches to 7/32 inches to create vibration, sound, and movement as water passes through the holes 511, 513. In another arrangement, it is to be appreciated that the forward body section 502 includes a forward body length from 60% to 70% of an overall length of the lure 500, and the rear tail section 504 includes a rear body length from 40% to 30% of the overall length of the lure 500. In this configuration, the forward body section 502 is heavier than the rear tail section 504. Although not illustrated, it is to be appreciated that the forward body section 502 can include a forward body length from 40% to 30% of an overall length of the lure 500, and the rear tail section 504 can include a rear body length from 60% to 70% of the overall length of the lure 500.

FIG. 6 illustrates another embodiment of a fishing lure including a segmented body construction of the invention. The lure 600 comprises a main forward body section/first body section 602 and a rear tail section 604, coupled via a connector selected from the group consisting of a swivel connector (not shown) and a split ring 606 that permits rotational freedom. The forward body section 602 can include a pair of opposing holes 603, 605 positioned approximately mid-body and approximately 1/16″ from the edge. A split ring 607, 609, including an associated colored blade 611, 613, can be mounted in respective holes 603, 605 to mimic the pectoral fins of a fish. Further, the rear tail section 604 can include a pair of opposing holes 615, 617 positioned proximal to the rear terminal end of the rear tail section 604. A split ring 619, 621, including an associated colored blade 623, 625, can be mounted in respective holes 615, 617 to mimic the tail fin motion of a fish.

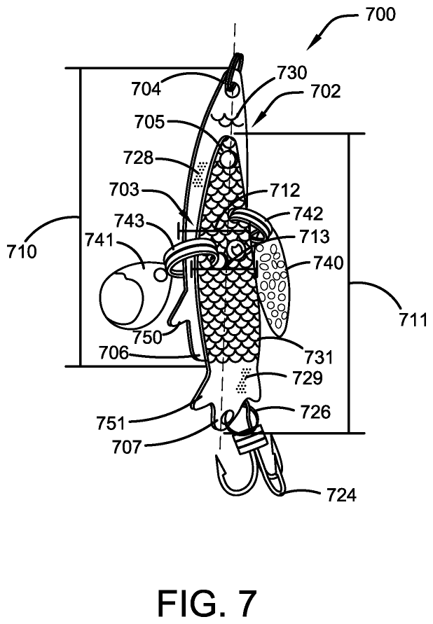

FIG. 7 illustrates a perspective view of another potential embodiment of the improved fishing lure of the present invention in accordance with the disclosed structure. The improved fishing lure 700 of the present invention is designed to improve fish-catching effectiveness by mechanical and visual enhancements over traditional spoon and castaway lures. More specifically, the fishing lure 700 includes a major body 702 and a minor body 703 formed from substantially rigid metallic material shaped in a specific configuration such as spoon, castaway, crocodile-like, or minnow-like configuration. The major body 702 extends longitudinally along a longitudinal axis 703 between a head end 704 and a tail end 706. The minor body 703 extends longitudinally along the longitudinal axis 703 between a head end 705 and a tail end 707. The minor body 703 is aligned with and offset from the major body 702. The offset comprises mounting the minor body 703 behind (i.e., downstream) from the major body 702 to produce a three-dimensional visual effect in the water. The major body 702 includes a major length 710 and a major width 712, and the minor body 703 includes a minor length 711 and a minor width 713. The major length 710 is equal to or greater than the minor length 711. The major width 712 is equal to or greater than the minor width 713. In one exemplary embodiment, the major length 710 comprising from 120 percent to 100 percent of the minor length 711. The major width 712 comprising from 140 percent to 100 percent of the minor width 713. In yet another exemplary embodiment, the major width 712 comprising from 120 percent to 100 percent of the minor width 713.

The improved fishing lure 700 includes a primary treble hook 724 affixed or coupled to the terminal or tail end 707 of the minor body 703 using a split ring or swivel connector 726 or any other similar connector. The treble hook 724 is configured to maintain a substantially trailing orientation relative to the major body 702 and minor body 703 during use of the fishing lure 100.

The fishing lure bodies 702, 703 comprise visually reflective outer surfaces 728, 729 which can be decorated with one or more colored geometric markings or holographic scaling patterns 730, 731 configured to enhance visual stimulus to fish in both cold and warm water environments. The fishing lure 700 can include an upper attractor 740 connected by a split ring or swivel connector 742, and/or a lower attractor 741 connected by a split ring or swivel connector 743. Additionally, the major body 702 can include a fin 750 along a lower edge of the major body 702. Similarly, the minor body 703 can include a fin 751 along a lower edge of the minor body 703. It should be noted that the fishing lure 700 is configured for manual or mechanical retrieval at variable speeds with intermittent jerking motions.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “segmented fishing lure with articulating tail, “segmented fishing lure”, “improved fishing lure”, and “fishing lure” are interchangeable and refer to the segmented fishing lure 100, 200, 300, 400, 500, 600, 700 of the present invention.

Notwithstanding the forgoing, the segmented fishing lure 100, 200, 300, 400, 500, 600, 700 of the present invention can be of any suitable configuration as is known in the art without affecting the overall concept of the invention, provided that it accomplishes the above stated objectives. One of ordinary skill in the art will appreciate that the segmented fishing lure 100, 200, 300, 400, 500, 600, 700 as shown in the FIGS. are for illustrative purposes only, and that many other configurations of the segmented fishing lure 100, 200, 300, 400, 500, 600, 700 are well within the scope of the present disclosure. Although the dimensions of the segmented fishing lure 100, 200, 300, 400, 500, 600, 700 are important design parameters for user convenience, the segmented fishing lure 100, 200, 300, 400, 500, 600, 700 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing lure comprising:
a lure body having a first body section, a second body section, and a diagonal split line between said first body section and said second body section; and
a coupling member;
wherein said lure body having a longitudinal axis between a head end and a tail end of said lure body;
wherein said diagonal split line dividing said lure body into said first body section and said second body section;
wherein said first body section having a first length and said second body section having a second length;
wherein said first length comprising from 60 percent to 70 percent of an overall length of said lure body;
wherein said diagonal split line is oblique to said longitudinal axis forming an angle between 30 degrees and 60 degrees relative to said longitudinal axis of said lure body;
wherein said first body section having at least a first aperture proximal to a rearward terminal edge of said first body section;
wherein said second body section having at least a second aperture proximal to a forward terminal edge of said second body section;
wherein said coupling member passes through said first aperture and said second aperture to selectively attach said first body section and said second body section; and
further wherein said coupling member selected from the group consisting of a first split ring and a first swivel connector for rotational and oscillatory movement of said second body section relative to said first body section.

2. The fishing lure of claim 1, wherein said second body section having a primary treble hook coupled to a rearward terminal edge of said second body section with another coupling member selected from the group consisting of a second split ring and a second swivel connector.

3. The fishing lure of claim 1, wherein said angle is between 35 degrees and 55 degrees relative to said longitudinal axis of said lure body.

4. The fishing lure of claim 1, wherein said angle is between 40 degrees and 50 degrees relative to said longitudinal axis of said lure body.

5. The fishing lure of claim 1, wherein said at least first aperture is circular having a first diameter from 1/20 inches to 1/14 inches.

6. The fishing lure of claim 5, wherein said at least second aperture is circular having a second diameter from 1/20 inches to 1/14 inches.

7. The fishing lure of claim 6, wherein said at least first aperture extends inward from said rearward terminal edge of said first body section.

8. The fishing lure of claim 7, wherein said at least second aperture extends inward from said forward terminal edge of said second body section.

9. The fishing lure of claim 8, wherein said at least first aperture having a first center from 1/16 inch to 3/16 inch from said rearward terminal edge of said first body section.

10. The fishing lure of claim 9, wherein said at least second aperture having a second center from 1/16 inch to 3/16 inch from said forward terminal edge of said second body section.

11. The fishing lure of claim 1, wherein at least one of said first body section and said second body section having at least one hole passing therethrough; and
further wherein said at least one hole extending at an angle from 20 degrees to 40 degrees relative to a surface of at least one of said first body section and said second body section.

12. The fishing lure of claim 1, wherein said coupling member selected from the group consisting of a pair of split rings and a pair of swivel connectors for rotational and oscillatory movement of said second body section relative to said first body section.

13. The fishing lure of claim 1, wherein at least one of said first body section and said second body section having a pair of opposing holes proximal to an edge; and
further wherein each of said pair of opposing holes having an associated split ring and a
colored blade mounted thereto.

14. A fishing lure comprising:
a lure body having a first body section, a second body section, a third body section, a first diagonal split line between said first body section and said second body section, and a second diagonal split line between said second body section and said third body section; and
a first coupling member and a second coupling member;
wherein said lure body having a longitudinal axis between a head end and a tail end of said lure body;
wherein said first diagonal split line and said second diagonal split line dividing said lure body into said first body section, said second body section, and said third body section;
wherein said first diagonal split line is oblique to said longitudinal axis forming an angle between 30 degrees and 60 degrees relative to said longitudinal axis of said lure body;
wherein said second diagonal split line is oblique to said longitudinal axis forming an angle between 30 degrees and 60 degrees relative to said longitudinal axis of said lure body;
wherein said first body section having at least a first aperture proximal to a rearward terminal edge of said first body section;
wherein said second body section having at least a second aperture proximal to a forward terminal edge of said second body section;
wherein said first coupling member passes through said first aperture and said second aperture to selectively attach said first body section and said second body section;
wherein said second body section having at least a third aperture proximal to a rearward terminal edge of said second body section;
wherein said third body section having at least a fourth aperture proximal to a forward terminal edge of said third body section;
wherein said second coupling member passes through said third aperture and said fourth aperture to selectively attach said second body section and said third body section; and
further wherein said first coupling member and said second coupling member selected from the group consisting of a first split ring and a first swivel connector for rotational and oscillatory movement of said first body section, said second body section, and said third body section.

15. The fishing lure of claim 14, wherein said first body section having a primary treble hook coupled to a forward terminal edge of said first body section with a third coupling member selected from the group consisting of a second split ring and a second swivel connector.

16. The fishing lure of claim 15, wherein said first diagonal split line is oblique to said longitudinal axis forming an angle between 35 degrees and 55 degrees relative to said longitudinal axis of said lure body, and further wherein said second diagonal split line is oblique to said longitudinal axis forming an angle between 35 degrees and 55 degrees relative to said longitudinal axis of said lure body.

17. The fishing lure of claim 15, wherein said first diagonal split line is oblique to said longitudinal axis forming an angle between 40 degrees and 50 degrees relative to said longitudinal axis of said lure body, and further wherein said second diagonal split line is oblique to said longitudinal axis forming an angle between 40 degrees and 50 degrees relative to said longitudinal axis of said lure body.

18. A fishing lure comprising:
a lure body having a first major body section and a second minor body section;
wherein said lure body having a longitudinal axis between a head end and a tail end of said lure body;
wherein said first major body section and said second minor body section aligned with said longitudinal axis;
wherein said second minor body section is aligned with and offset from said first major body section;
wherein said second minor body section is downstream from said first major body section;
wherein said first major body section comprises a major length and a major width;
wherein said second minor body section comprises a minor length and a minor width;
wherein said major length is from 120 percent to 100 percent of said minor length; and
wherein said major width is from 140 percent to 100 percent of said minor width.

19. The fishing lure of claim 18, wherein said major width is from 120 percent to 100 percent of said minor width.

20. The fishing lure of claim 19, further comprising a treble hook affixed to a terminal end of said second minor body section, wherein said treble hook is in a trailing orientation relative to said first major body section and said second minor body section during use of the fishing lure.
